(19) United States
(12) Patent Application Publication
(10) Pub. No.: US 2006/0164549 A1
(43) Pub. Date: Jul. 27, 2006

(54) System management scheme for a signal-processing-based decision support system

(76) Inventor: Walid Ali, Montrose, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/537,619

(22) PCT Filed: Nov. 25, 2003
(86) PCT No.: PCT/IB03/05423

§ 371 Date: Jun. 3, 2005

(30) Foreign Application Priority Data
Dec. 5, 2002 (US) 60413342

(51) Int. Cl. H04N 5/14

(52) U.S. Cl. 348/571

(57) ABSTRACT

A decision support system and a method for a signal processing system includes a video processing system for receiving and processing a video stream and providing a video output; a video quality evaluation module that receives the video output from the video processing system and evaluates the quality according to predetermined criteria; a video optimizer adapted for receiving the evaluated quality of the video output from evaluation module and level settings of parameters and for setting controls of the levels settings of parameters of video processing system, said video optimizer including a Multi Objective Genetic Algorithm (MOGA) engine, wherein the MOGA uses genetic algorithms to optimize the settings of controls for video processing system to optimize image quality at a predetermined level.

The present invention relates to the management of a signal-processing based support system for Decision Support Systems (DSS). More particularly, the present invention relates to the development of a DSS whose components are generally non-linear.

When streaming multimedia data over scarce-resource devices (e.g. streaming video/multimedia over wireless networks) there is always a tradeoff between quality of the received signal and the associated costs. For example, in the case where one chooses to stream video over a wireless device, such as a Personal Data Assistant (PDA) of a cell phone with a G3 configuration, there is the possibility that network congestion (which may or may not have been foreseen) and/or a sudden decrease of the available bandwidth might occur. It is also possible that the available storage medium might also suddenly decrease unexpectedly.

Such unexpected variations in bandwidth availability can affect the multimedia stream in a catastrophic fashion. For example, in the case of video conferencing (which may or may not occur on a cell phone) the call could be dropped due to network congestion.

Should one be downloading multimedia (e.g. purchasing a movie via downloading to a storage device) any variation in bandwidth that produces a drop would cause the session to fail and the user would be required to restart the session.

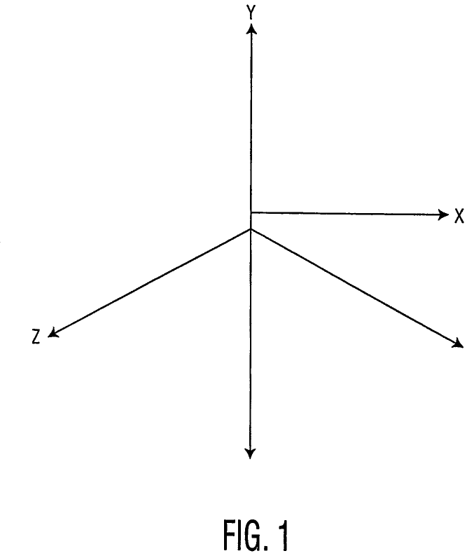

In addition, there are many other factors beside image quality that should be taken into account, and these factors have not been considered by the prior art. For example, there are competing factors of power dissipation, market costs, and time to market versus image quality, as shown in FIG. 1. The relationships between such factors do not always fit into proportions such that a solution can be obtained algebraically or easily. However, there is a need for an overall scheme to provide a management scheme for a signal-processing-based decision support system.

Accordingly, it is an aspect of the present invention to provide a system that manages a signal-processing-based decision support system. The decision support system is capable of dynamically deciding the best allocation of bandwidth to reduce/eliminate the possibility that multimedia streaming has catastrophic interrupts, in accordance with other competing factors such as power dissipation, market costs, etc. In other words, the system automatically decides the best allocation under the circumstances and adapts to further changes in circumstances. Whether the changed circumstances are due to one or a combination of network congestion, decrease in bandwidth available, temporary loss of a storage medium, power reduction, etc., the system will automatically adjust the parameters of the multimedia stream to preserve the most important aspects thereof. During a conference call, typically preserving the clarity of the audio would be more important than displaying a slightly fuzzy video, so the re-allocation in that particular case can be made with ensuring that audio quality is preserved at a certain level.

FIG. 1 is a diagram showing a few of the competing factors in a decision support system.

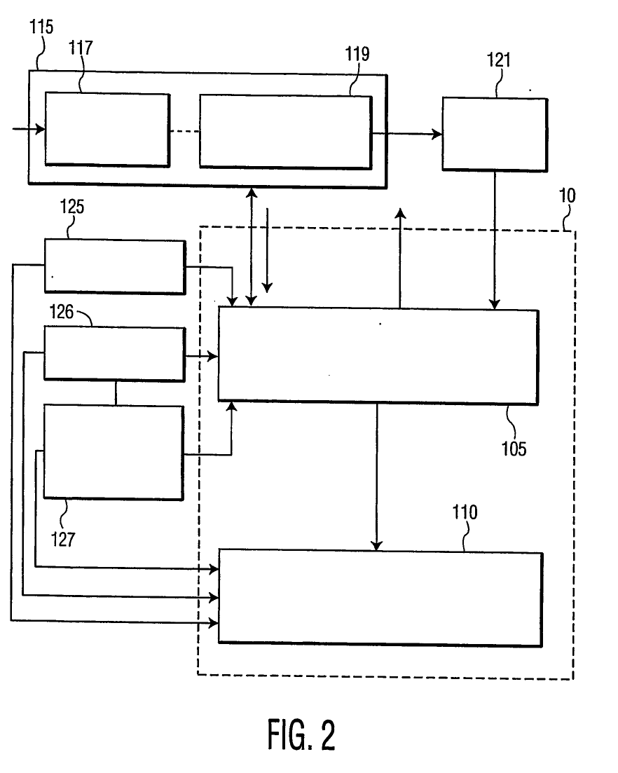

FIG. 2 illustrates a simplified block diagram of the system according to an embodiment of the present invention.

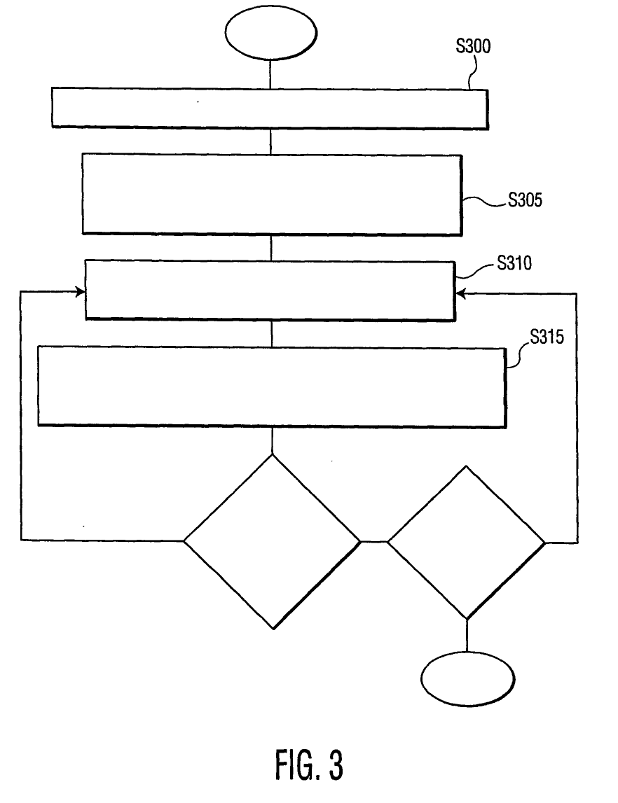

FIG. 3 is a flowchart highlighting an aspect of the present invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

DSS for signal-processing systems are unknown heretofore because the constituent components are generally highly non-linear, the nature of their interaction is not well defined and are most likely non-deterministic. In the modeling process disclosed herein, the signal processing system is a complex modeling system that includes structure that controls the associated level of performance, and the expense associated with such systems. Expense associated with these systems could be broken down into manufacturing costs, level of performance for unit money, time to market, and effect on market share.

FIG. 2 illustrates an aspect of the video decision support system according to the present invention.

An optimizer module 100 comprises a Multi-Objective Genetic Algorithm (MOGA) sub-module 105 and a statistical analyzer 110. The MOGA searches the hyper space whose coordinates are the different kinds of expenses and the signal processing parameters. The MOGA enables a non-deterministic search space adequately and permits the finding of global optima without being stuck at local optima from initial indications of genetic algorithm models. Applicant respectfully incorporates by reference U.S. patent application Ser. No. 09/717,981 entitled “System and Method for Optimizing Parameter settings in a chain of Video Processing Algorithms” by Walid S. I. Ali and Cornelis Van Zon, and Ser. No. 09/734,823 entitled “System and Method for providing a Scalable Dynamic Objective Metric for automatic Video Quality Evaluation” by Walid S. I. Ali and Cornelis Van Zon as background material regarding the role of genetic algorithms and optimizing control parameter settings by a multi-objective engine to help formulate better search points to find global optima.

The statistical analyzer 110, which analyzes inputs such as market costs 125 and time to market 126, can provide in conjunction with the rest of the system provide formal estimates for the relationship between image quality, manufacturing costs, time to market, power dissipation, bandwidth usage, etc. There can be additional/extra factors (any extra factors that may need to be or preferably should be analyzed in this scheme), and they are represented by box 127 (e.g. bandwidth, network congestion, etc). Typically, the statistical analyzer will interpolate the data which it compiles, and such information can be provided to the MOGA for further analysis.

A video-processing system 115 is adapted for receiving a video stream input. The system includes a picture color improvement module 117 and a sharpness enhancement and noise cancellation modules 119. A video quality evaluation module 121 receives the video from the video processing system 115 and rates the quality (e.g. good, bad and possibly many variations therebetween) based on predetermined objective criteria.

The optimizer module 100 will initially provide for a level setting of parameters and controls based on the initial criteria regarding image quality, costs, power dissipation, etc. During operation, the optimizer module 100 communicates with the video processing system to change level settings in the video processing system 115 of parameters, controls, etc., which in turn causes the video output to be modified. The modification of the video output, in turn, may cause the video quality evaluation module 121 to change. As the video quality is evaluated, this evaluation is provided to the MOGA 105 of the optimizer module 100, wherein the MOGA will provide for further changes in level settings and parameters until the video quality evaluation module 121 provides the optimum evaluation (taking into account, of course, the other previously discussed competing factors considered by the optimize module). The video quality evaluation module may evaluate a video stream in components, for example, with an overall quality rating and/or one for the audio, video and text portions of the stream. In this way, the MOGA 105 can prioritize which portion of the stream should quality be maintained if there is a requirement to cut back on some transmission settings.

For example, during a conference call on a G3 cellphone, the video quality may be lower in priority than audio quality, so at times the video quality would be sacrificed rather than lose the audio portion of the conference call. This change in quality may be caused by network congestion, sudden reduction in available bandwidth, reduced power availability, changed storage requirements, etc.

The MOGA permits good solutions (high signal quality, e.g. with video, and crisp clear video stream) with a high level of confidence. The multi-objective search engine has the capability to change the structure and the parameters of the signal processing system under study and its associated level of performance is reported back to the multi-objective engine to help formulating better search points.

FIG. 3 is a flowchart providing explanation of an aspect of the present invention. At step 300, a video stream is received by the video processing system 115.

At step 305, the system, which preferably has initial default settings for controls and parameters, so that color improvement by the module 117 and sharpness enhancement and noise cancellation are output to the video quality evaluation module 121.

At step 310, the video quality evaluation module evaluates the quality, and reports the evaluation to the video optimizer 100 (particularly the MOGA 105). The quality evaluation is preferably according to scalable objective metrics referred to in the previously incorporated by reference U.S. patent application Ser. No. 09/734,823, but it is not an absolute requirement of the present invention. The video quality evaluation module 121 provides the quality evaluation to the MOGA of the video optimizer 100.

At step 315, the MOGA analyzes the video quality evaluation, and in conjunction with receipt of the level settings of parameters of the video processing system, and the costs, time and other factors, processes the information using genetic algorithms and provides settings of control parameters to the video processing system 115.

At step 320, it is determined whether or not the video stream has ended or there is another video stream. If there are more evaluations from the video quality evaluation module 121, the MOGA will evaluate the criteria (such as control settings, video quality, etc.) and update the level settings of parameters and controls. It is also possible for the MOGA to re-evaluate at intervals, such as every other stream, for example, or even more than once per stream, assuming that computing power is fast enough to make such re-evaluations at fractions of a stream.

While several aspects of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope of the claimed invention.

For example, when the statistical analyzer is interpolating factors such as “time to market” the system is more of a prototype than a finished consumer product, as it allows engineers to view different image qualities without just varying costs, but market timing. However, the system can also be a practical system that functions in, for example, conferencing equipment at a retail level. In such a scenario, users may be able to prioritize various factors that have an overall effect on image quality. Therefore, it is intended that the present invention not be limited to the particular embodiment disclosed as the best mode contemplated for carrying out the present invention, but that the present invention include all embodiments falling within the scope of the appended claims.

What is claimed is:

1. A decision support system for a signal processing system comprising:
a video processing system 115 for receiving and processing a video stream and providing a video output;
a video quality evaluation module 121 that receives the video output from the video processing system and evaluates the quality according to predetermined criteria;
a video optimizer 100 adapted for receiving the evaluated quality of the video output from evaluation module 121 and level settings of parameters and for setting controls of the levels settings of parameters of video processing system 115, said video optimizer including a Multi Objective Genetic Algorithm (MOGA) engine, wherein said MOGA uses genetic algorithms to optimize the settings of controls for video processing system 115 to optimize quality at a predetermined level.

2. The system according to claim 1, wherein said optimizer 100 includes a statistical analyzer 110 that associates at least one item with setting controls of the level settings of parameters of video processing system 115 to receive a certain image quality evaluated by quality evaluation module 121.

3. The system according to claim 2, wherein said at least one item includes manufacturing costs.

4. The system according to claim 3, wherein the manufacturing costs include time to market.

5. The system according to claim 2, wherein said at least one item analyzed by the statistical analyzer 110 includes bandwidth availability.

6. The system according to claim 2, wherein said at least one item analyzed by the statistical analyzer 110 includes network availability.

7. The system according to claim 1, wherein the image quality evaluation module evaluates quality of multimedia according to video, audio and text, and the MOGA 105 includes prioritizing instructions so as to prioritize the quality of audio, video and text components of a video stream.

8. The system according to claim 8, wherein the system comprises a telephone with video capability and the quality of the audio portion has the highest priority.

9. The system according to claim 8, wherein the system comprises a conference call system and the quality of the video portion has the highest priority.

10. The system according to claim 8, wherein the quality of audio is prioritized according to network congestion.

11. The system according to claim 8, wherein the quality of audio is prioritized according to bandwidth availability.

12. The system according to claim 8, wherein the quality of audio is prioritized according to power dissipation.

13. A method for a decision support system for a signal-based processor, comprising the steps of:
(a) receiving a video-processing stream by a video processing system s300;
(b) processing color, sharpness and noise cancellation according to initial default settings and parameters s305;
(c) evaluating video quality by an objective video quality evaluation module s310;
(d) using a video optimizer to provide level settings and control parameters for the video processing system based on feedback of quality from the video quality evaluation module;
(e) determining s320 whether the video stream has ended, and repeating steps (c) through (e) until the video stream has ended.

14. The method according to claim 14 wherein step (e) further includes determining whether any additional video streams require processing.

15. The method according to claim 14, wherein the optimizer in step (a) includes a MOGA engine and a statistical analyzer.

16. The method according to claim 15, wherein the statistical analyzer will analyze at least one item associated with setting controls of the level settings of parameters of the video processing system to receive a certain image quality evaluated by a quality evaluation module.

17. The method according to claim 16, wherein the at least one item comprises a plurality of items and includes bandwidth availability, and the statistical analyzer interpolates the items.

18. The method according to claim 16, wherein the at least one item comprises a plurality of items and includes power dissipation, and the statistical analyzer interpolates the items.

19. The method according to claim 16, wherein the at least one item comprises a plurality of items and includes network availability, and the statistical analyzer interpolates the items.

20. The method according to claim 16, wherein the at least one item comprises a plurality of items and includes time to market, and the statistical analyzer interpolates the items.
